(19) United States
(12) Patent Application Publication
(10) Pub. No.: US 2022/0092476 A1
(43) Pub. Date: Mar. 24, 2022

(54) DEPENDENCE RELATIONSHIP DETECTION DEVICE AND DEPENDENCE RELATIONSHIP DETECTION METHOD

(71) Applicant: NEC Corporation, Minato-ku, Tokyo (JP)

(72) Inventor: Manabu NAKANOYA, Tokyo (JP)

(73) Assignee: NEC Corporation, Minato-ku, Tokyo (JP)

(21) Appl. No.: 17/428,173

(22) PCT Filed: Nov. 25, 2019
(86) PCT No.: PCT/JP2019/045987

§ 371 Date: Aug. 3, 2021

(30) Foreign Application Priority Data
Feb. 6, 2019 (JP) 2019-019377

(51) Int. Cl. G06N 20/00; G06F 9/445; G06F 8/60

(52) U.S. Cl. CPC G06N 20/00; G06F 8/60; G06F 9/44505

(57) ABSTRACT

A dependence relationship detection device 20 includes an execution unit 21 for executing a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

### TECHNICAL FIELD

The present invention relates to a dependence relationship detection device and a dependence relationship detection method, and in particular to a dependence relationship detection device and a dependence relationship detection method used in automating construction or deployment of an information system.

### BACKGROUNG ART

The construction tasks of an IT (Information Technology) system consisting of servers and communication network devices, or the like mainly comprises three procedures of designing, embodying deployment task, and execution of deployment. The design procedure includes, for example, embodying components, determining relationships among the components, and examining setting items within each component.

The above construction tasks are performed, for example, by technicians manually performing each procedure. However, tools that automatically perform the second and third procedures related to deployment (hereinafter referred to as automation tools) are also often used in the construction tasks.

For example, the automation tool described in Non Patent Literature (NPL) 1 and the automation tool described in NPL 2 change the state of the target IT system to the state desired by the user when the state of the IT system desired by the user is declaratively described.

When changing the state of an IT system, the automation tools described in NPL 1 and NPL 2 do not make the users of the automation tools aware of the specific change tasks. By using automation tools, IT system administrators can automate many of the tasks involved in deployment.

Each of the above automation tools defines its own notation based on its own grammar so that the configuration of the IT system can be described. The user of the automation tool describes the desired state of the IT system according to the defined notation.

Each of the above automation tools also provides a reusable template for describing the configuration for each target for which the configuration is set, such as middleware or specific network devices.

For example, a template includes the operations required to set up the target configuration and the definition of the parameters of the operations. The operations required to set up the target configuration are, for example, rewriting the configuration file, inputting commands from the command line interface, and executing various Application Programming Interfaces (APIs).

The parameters mainly represent the values written in the configuration file, the arguments at the time of command input or API execution, and the state of the operation target after the operation. The user of an automation tool can more easily express the desired state of an IT system by specifying only the values of the parameters to be specified uniquely in the template.

In addition, the structure of the template provided by many automation tools is a structure that allows recursive calls. In other words, the user of an automation tool can generate a new template by combining multiple templates.

For the above reasons, the user of an automation tool can define the configuration of an IT system that combines multiple middleware, communication network devices, etc., in a batch using the automation tool, and even deploy it. In principle, the user of the automation tool is required to manually generate a template describing the configuration to be used by the automation tool.

### CITATION LIST

### Non Patent Literature

NPL 1: “Puppet”, [online], Puppet, [retrieved Jan. 24, 2019]

NPL 2: “Ansible”, [online], Red Hat, [retrieved Jan. 24, 2019]

### SUMMARY OF INVENTION

### Technical Problem

As mentioned above, a template used in an automation tool defines multiple operations that are required to set up the target configuration. Between the multiple operations defined, there may be an influence or a dependence relationship that each operation has on the other. In other words, the user of an automation tool may be required to carefully consider the influence and the dependence relationship between multiple operations, and describe the important influence and dependence relationship in the template.

For example, consider an automation tool that has a text file as a configuration file, and by reading the configuration file when the service is started, the software is configured and controlled to behave according to the description in the configuration file.

The template provided by the above automation tool defines two operations: the operation “rewrite configuration file” and the operation “start service”. The operation “rewrite configuration file” is an operation performed for the purpose of changing the software configuration. However, in order for the configuration changes to be reflected, the operation “start service” must also be performed due to the specifications of the software operation described above.

The above relationship that exists between two operations and are required to be executed in tandem is expressed in the template provided by the automation tool as a dependence relationship defined between the target operation and a parameter related to the state of another operation that is required to be executed in tandem.

In the above example, in the template provided by the automation tool, the operation “rewrite configuration file” defines a dependence relationship on the parameter “restart” regarding the status of the operation “start service”.

If there is excess or deficiency in the definition of dependence relationships, the configuration may not be set correctly even if the parameters are properly set in the template. Therefore, developers of automation tools that generate templates and developers and operators of IT systems often check and test the relationships among multiple operations to define the dependence relationships in the template. In the following, the above task on the relationships among multiple operations is called verification.

However, due to the increase in the number of operations caused by the addition of operations to a single template and the increase in the number of operations caused by the recursive definition of templates, or the like, the number of combinations of operations to be verified easily increases exponentially. In other words, it is difficult to perform sufficient verification for a template that is larger than a given size.

Therefore, it is an object of the present invention to provide a dependence relationship detection device and a dependence relationship detection method that can easily detect a dependence relationship in a relatively large template, solving the above-mentioned problems.

### Solution to Problem

A dependence relationship detection device according to the present invention includes an execution means which executes a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

A dependence relationship detection method according to the present invention includes executing a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

A computer readable recording medium according to the present invention stores a dependence relationship detection program that, when executed by a computer, performs executing a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

### Advantageous Effects of Invention

According to this invention, it is easily possible to detect a dependence relationship in a relatively large template.

### BRIEF DESCRIPTION OF DRAWINGS

FIG. 1 is a block diagram showing an example of the configuration of the first example embodiment of a dependence relationship detection device according to the present invention.

FIG. 2 is an explanatory diagram showing an example of a reinforcement learning task definition.

FIG. 3 is an explanatory diagram showing an example of a template correspondence.

FIG. 4 is an explanatory diagram showing an example of a result log obtained by the reinforcement learning execution unit 130 by executing a reinforcement learning task.

FIG. 5 is an explanatory diagram showing an example of an analysis result obtained by the result log analysis unit 140 from a result log.

FIG. 6 is an explanatory diagram showing another example of an analysis result obtained by the result log analysis unit 140 from a result log.

FIG. 7 is a flowchart showing the operation of the analysis result output process by the dependence relationship detection device 100 of the first example embodiment.

FIG. 8 is a flowchart showing the operation of the reinforcement learning process by the reinforcement learning execution unit 130 of the first example embodiment.

FIG. 9 is a block diagram showing an example of the configuration of the second example embodiment of a dependence relationship detection device according to the present invention.

FIG. 10 is a flowchart showing an operation of an analysis result output process by the dependence relationship detection device 101 of a second example embodiment.

FIG. 11 is an explanatory diagram showing an example of a hardware configuration of a dependence relationship detection device according to the present invention.

FIG. 12 is a block diagram showing an overview of a dependence relationship detection device according to the present invention.

### DESCRIPTION OF EMBODIMENTS

### First Example Embodiment

[Description of Configuration]

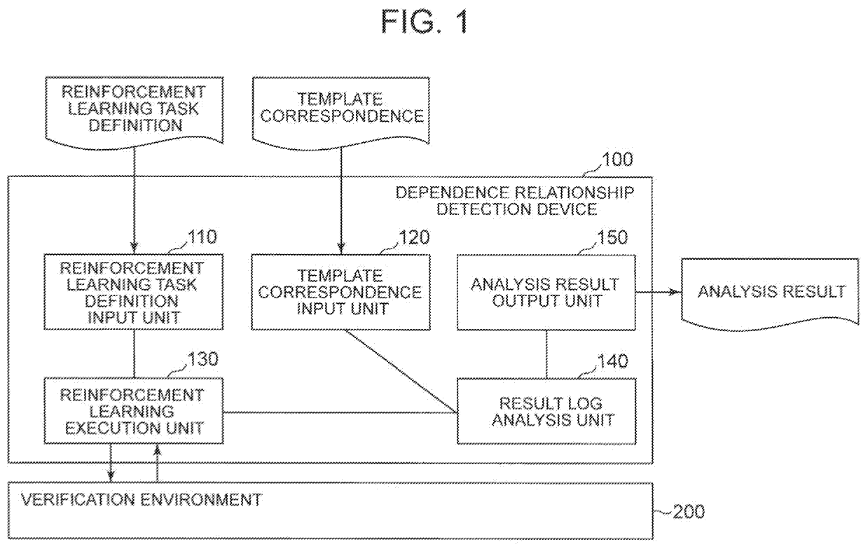

Hereinafter, example embodiments of the present invention will be described with reference to the drawings. FIG. 1 is a block diagram showing an example of the configuration of the first example embodiment of a dependence relationship detection device according to the present invention.

As mentioned above, it takes a lot of effort to correctly verify and describe a dependence relationship between an operation described in the template generated for an automated deployment and a state in which the operations can be executed. An automation tool, which automates a deployment of IT system, is used for the above automated deployment. Especially for a relatively large template, it requires more effort.

This example embodiment of a dependence relationship detection device performs a task of reinforcement learning (hereinafter, referred to as a reinforcement learning task) using the template to be verified. The dependence relationship detection device checks whether there is excess or deficiency in the dependence relationships defined in the template by analyzing log information obtained by the reinforcement learning task using information on the correspondence between state transitions and states input in advance.

In order to efficiently verify the dependence relationships defined in a template provided by the automation tool that performs a deployment automatically, it is required to select an appropriate combination from a huge number of test pattern combinations and to perform evaluation after the selected combination is executed.

The process of selecting combinations and executing the combination is done in the search process in reinforcement learning. By analyzing the log information of the search process, the dependence relationship detection device can check whether there is excess or deficiency in the dependence relationships defined in the template.

In addition, when reinforcement learning is performed, learning of control tasks with different optimal control depending on the state of the environment can be performed without preparing the learning data used in usual machine learning (supervised learning) in advance.

In reinforcement learning, the state information of the environment is used instead of feature data of usual machine learning, and the values observed from the environment or given by the environment, called reward, are used instead of the label data.

As shown in FIG. 1, the dependence relationship detection device 100 of this example embodiment includes a reinforcement learning task definition input unit 110, a template correspondence input unit 120, a reinforcement learning execution unit 130, a result log analysis unit 140, and an analysis result output unit 150.

As shown in FIG. 1, a reinforcement learning task definition is input to the reinforcement learning task definition input unit 110. In addition, a template correspondence is input to the template correspondence input unit 120.

As shown in FIG. 1, the dependence relationship detection device 100 is communicatively connected to a verification environment 200. The reinforcement learning execution unit 130 executes a reinforcement learning task in the verification environment 200. After the reinforcement learning task is executed, the analysis result output unit 150 outputs an analysis result.

The user inputs the reinforcement learning task definition, which indicates the reinforcement learning task to be executed in order for a deployment procedure of the IT system to be learned, for example, into the reinforcement learning task definition input unit 110. The user also inputs a template correspondence that indicates correspondence between the template provided by an automation tool to be verified and a state and an action defined in the reinforcement learning task definition into the template correspondence input unit 120.

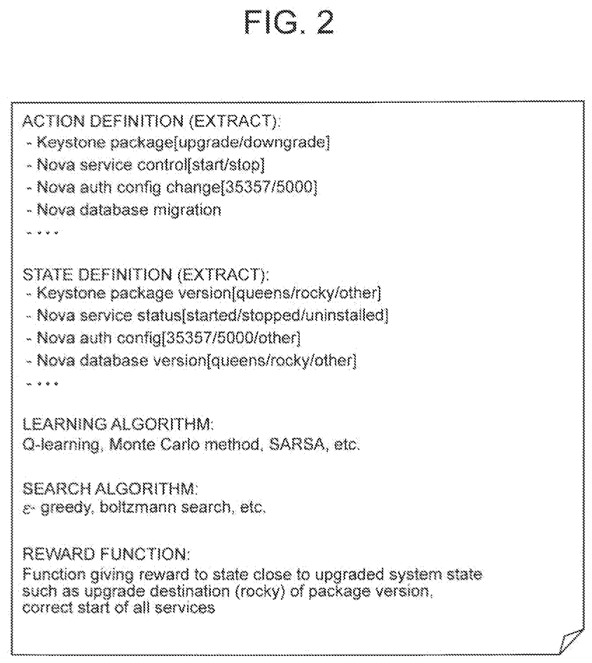

FIG. 2 is an explanatory diagram showing an example of a reinforcement learning task definition. The reinforcement learning task definition shown in FIG. 2 is an example of a reinforcement learning task definition for learning an upgrade procedure of OpenStack that is an open-source cloud infrastructure software.

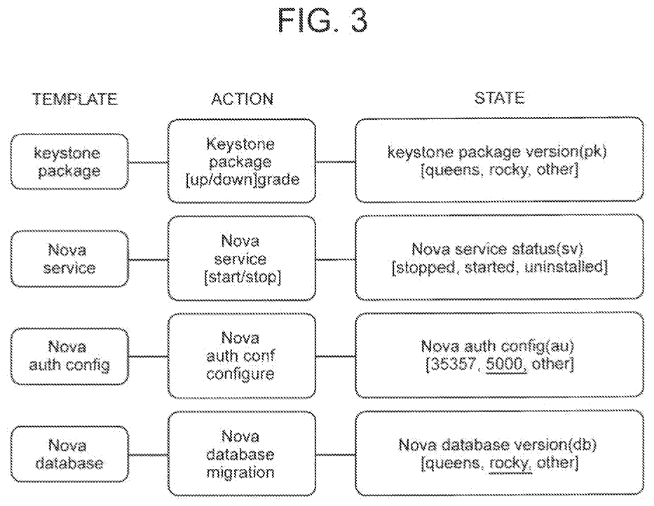

FIG. 3 is an explanatory diagram showing an example of a template correspondence. The template correspondence shown in FIG. 3 corresponds to the reinforcement learning task definition shown in FIG. 2.

The action indicated by the action definition described in the reinforcement learning task definition shown in FIG. 2 is characterized by the fact that the template provided by the automation tool to be verified is used to execute the action. The action indicated by the action definition corresponds to the operation defined in the template described above.

For example, the first line of the action definition shown in FIG. 2, “Keystone package [upgrade/downgrade]” indicates an operation to update and downgrade Keystone software that is a subcomponent of OpenStack.

The update and downgrade of Keystone software are, for example, performed using a package management system of Linux (registered trademark) type OS (Operating System) such as APT (Advanced Packaging Tool) or YUM (Yellowdog Updater Modified).

The action indicated by the action definition of this example embodiment is executed using the template provided by the automation tool. In other words, the template provided by the automation tool to be verified is used when the action defined in the reinforcement learning task definition shown in FIG. 2 is executed.

Each state definition described in the reinforcement learning task definition shown in FIG. 2 corresponds to an element that characterizes the state, respectively. The state space over the entire system to be learned is defined by the direct product of each element.

For example, the first line of the state definition shown in FIG. 2 indicates a state element that represents the version of the Keystone software package. In addition, the state element indicated by the first line of the state definition is defined to have three possible states that are queens, rocky, and other. This example embodiment of the reinforcement learning task definition has state definitions for the states that are assumed to change as a result of one or more actions being performed for each defined action.

In addition, the search algorithm, learning algorithm, and reward function described in the reinforcement learning task definition shown in FIG. 2 are all used when the reinforcement learning task is executed.

In the template correspondence shown in FIG. 3, in addition to the correspondence between actions and states defined in the reinforcement learning task definition shown in FIG. 2 the template used when each action is executed is also specified.

For example, the top row correspondence shown in FIG. 3 indicates that the actions of upgrading and downgrading a Keystone package change the state of the package version (keystone package version) and are performed using the template “Keystone package”.

The underlined states shown in FIG. 3 are the states that are intended as the transition destination after the action. For example, the bottom correspondence shown in FIG. 3 indicates that the Nova database version is intended to transition to rocky when the NovaDB migration action is executed.

Although not underlined, correspondence in the top row and correspondence in the second row also contain states that are intended as transition destinations after the action.

The input reinforcement learning task definition is input from the reinforcement learning task definition input unit 110 to the reinforcement learning execution unit 130. The reinforcement learning execution unit 130 executes the reinforcement learning task using the input reinforcement learning task definition.

In this example embodiment, the IT system subject to reinforcement learning is constructed in the verification environment 200. The reinforcement learning execution unit 130 executes the action indicated by the input reinforcement learning task definition using the template provided by the automation tool on the verification environment 200.

In addition, the reinforcement learning execution unit 130 obtains the state of the IT system after the action has been executed. The reinforcement learning execution unit 130 performs processing required when a general reinforcement learning task is executed, such as computing a reward based on the obtained state and the reward function.

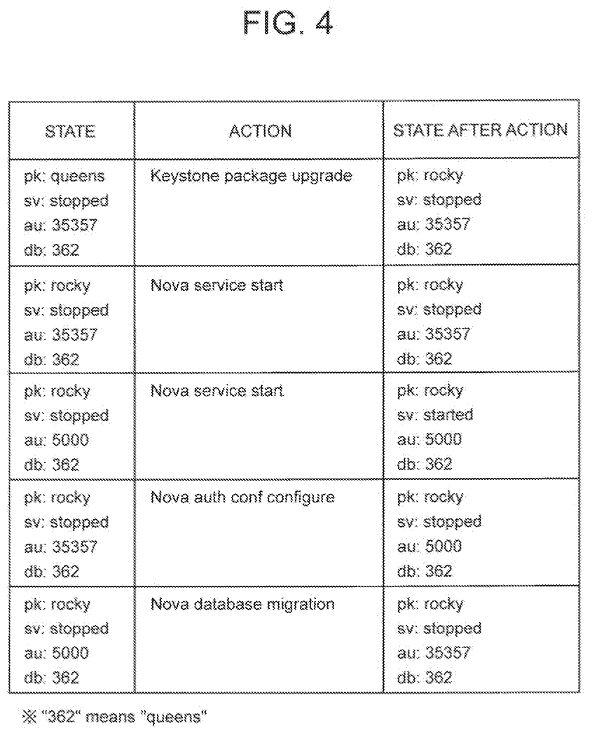

FIG. 4 is an explanatory diagram showing an example of a result log obtained by the reinforcement learning execution unit 130 by executing a reinforcement learning task. The obtained result log is log data of the search that occurred in learning procedure in which the automation tool was used.

Each result log shown in FIG. 4 indicates the state before the execution of the action, the contents of the action, and the state after the execution of the action. Each state shown in FIG. 4 is represented by the abbreviation (name in parentheses) shown in FIG. 3.

For example, the first result log from the top shows that the package version state of Keystone has changed from queens to rocky due to the execution of the Keystone package upgrade action.

After completing the reinforcement learning task, the reinforcement learning execution unit 130 inputs the obtained result log to the result log analysis unit 140. The result log analysis unit 140 analyzes the result log based on the contents indicated by the template correspondence input from the template correspondence input unit 120.

In the analysis process, the result log analysis unit 140 compares the correspondence between the action and the state indicated by the template correspondence and the correspondence between the action indicated by the result log and the state that has changed after the action. After the comparison, the result log analysis unit 140 predicts the condition under which the intended state change occurs after the action with respect to each action, taking into account the state of the entire IT system.

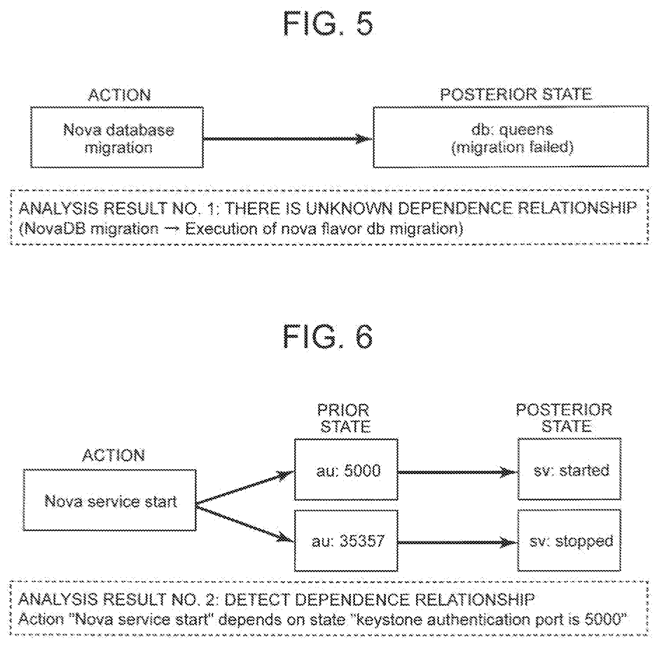

FIG. 5 is an explanatory diagram showing an example of an analysis result obtained by the result log analysis unit 140 from a result log. The analysis result shown in FIG. 5 corresponds to the contents of the fifth result log from the top shown in FIG. 4.

The posterior state shown in FIG. 5 describes that the state of the db is not rocky but remains queens (“362” shown in FIG. 4). Therefore, since the intended state change has not occurred even though the action “Nova database migration” is executed regardless of the prior state, the result log analysis unit 140 analyzes that there is an unknown dependence relationship as shown in FIG. 5.

The result log analysis unit 140 may use the result of a statistical determination based on information in the result log in which the results of similar actions performed multiple times are recorded as the analysis result. The statistically determined analysis result may suggest the existence of a state in which the action is dependent on a state other than the state defined in the reinforcement learning task definition.

For example, such a dependence relationship may turn out the execution of an action (operation) that is not defined in the reinforcement learning task definition is required, such as “execute nova flavor db migration” shown in FIG. 5. Therefore, a state where the action is dependent on a state other than the state defined in the reinforcement learning task definition is a condition for success of an action.

The result log analysis unit 140 may also analyze the condition regarding the entire state space defined in the reinforcement learning task definition when a specific action is performed, by statistically processing the result log of the reinforcement learning task. The condition to be analyzed is a condition for change in the state associated by the template correspondence. After the analysis, the result log analysis unit 140 presents the dependence relationship on the states for a particular action to be successful.

FIG. 6 is an explanatory diagram showing another example of an analysis result obtained by the result log analysis unit 140 from a result log. The analysis result shown in FIG. 6 corresponds to the contents of the second result log from the top and the third result log from the top shown in FIG. 4.

As shown in FIG. 6, the result log analysis unit 140 analyzes that whether or not the intended state change (sv:stopped→sv:started) occurs after the action “Nova service start” is executed depends on the prior state of the au. Specifically, if the prior state of the au is 5000, the intended state change will occur. If the prior state of the au is 35357, the intended state change does not occur.

Therefore, the result log analysis unit 140 detects the dependence relationship that the action “Nova service start” depends on the state “keystone authentication port is 5000”. The result log analysis unit 140 summarizes the analysis results shown in FIG. 5 and FIG. 6 for each action.

The result log analysis unit 140 inputs the summarized analysis result for each action to the analysis result output unit 150. The analysis result output unit 150 outputs the inputted contents as the final analysis result. The analysis result output by the analysis result output unit 150 is the analysis result that the dependence relationship detection device 100 presents to the user.

[Description of Operation]

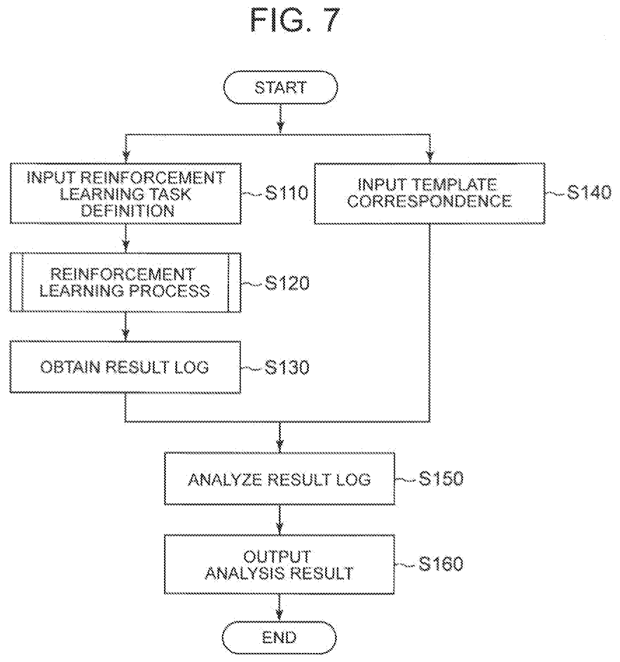

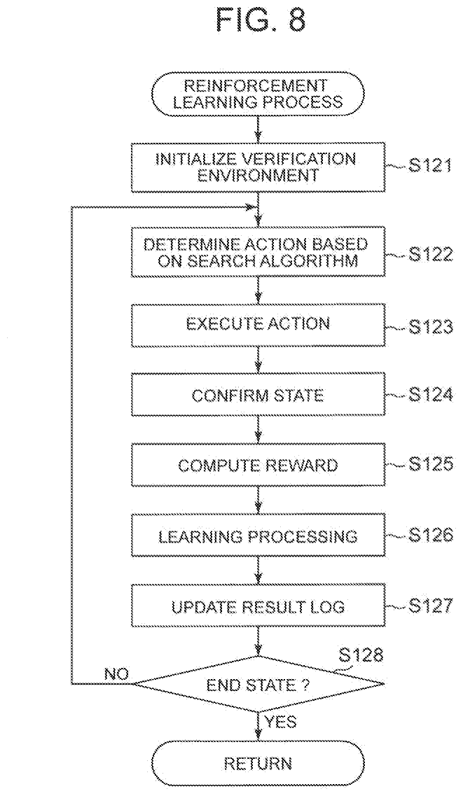

Hereinafter, the operation of the dependence relationship detection device 100 of this example embodiment will be described with reference to FIGS. 7 and 8.

First, the operation of outputting an analysis result of the dependence relationship detection device 100 of this example embodiment will be described with reference to FIG. 7. FIG. 7 is a flowchart showing the operation of the analysis result output process by the dependence relationship detection device 100 of the first example embodiment.

First, the user inputs a reinforcement learning task definition into the reinforcement learning task definition input unit 110 (step 5110). The reinforcement learning task definition input unit 110 inputs the input reinforcement learning task definition to the reinforcement learning execution unit 130.

Next, the reinforcement learning execution unit 130 executes the reinforcement learning process to perform the reinforcement learning task based on the input reinforcement learning task definition (step S120). After executing the reinforcement learning process, the reinforcement learning execution unit 130 obtains the result log (step S130). Next, the reinforcement learning execution unit 130 inputs the obtained result log to the result log analysis unit 140.

The user also inputs a template correspondence into the template correspondence input unit 120 (step S140). Next, the template correspondence input unit 120 inputs the input template correspondence to the result log analysis unit 140.

Next, the result log analysis unit 140 analyzes the input result log using the input template correspondence (step S150). Next, the result log analysis unit 140 summarizes the analysis results by action and inputs the summarized contents to the analysis result output unit 150.

Next, the analysis result output unit 150 outputs the inputted contents as the final analysis result (step S160). After outputting the analysis result, the dependence relationship detection device 100 ends the analysis result output process.

Next, the reinforcement learning process of step S120, which constitutes the analysis result output process shown in FIG. 7, will be explained with reference to FIG. 8. FIG. 8 is a flowchart showing the operation of the reinforcement learning process by the reinforcement learning execution unit 130 of the first example embodiment.

When the reinforcement learning process is started, the reinforcement learning execution unit 130 first initializes the verification environment 200 (step S121).

Next, the reinforcement learning execution unit 130 determines the action to be executed according to the search algorithm specified in the reinforcement learning task definition (step S122).

Next, the reinforcement learning execution unit 130 executes the action determined in step S122 in the verification environment 200 using the template provided by the automation tool (step S123).

Next, the reinforcement learning execution unit 130 confirms the state of the IT system constructed in the verification environment 200 after the action has been executed (step S124). Next, the reinforcement learning execution unit 130 computes the reward using the reward function specified in the reinforcement learning task definition (step S125).

Next, the reinforcement learning execution unit 130 executes the learning process according to the learning algorithm specified in the reinforcement learning task definition, based on the action determined in step S122, the state confirmed in step S124, and the reward computed in step S125 (step S126).

In step S126, for example, the learning process of the procedure for deployment of the IT system is executed. The deployment procedure to be learned is a procedure that assumes the state of the IT system constructed in the verification environment 200 after the action has been executed.

Next, the reinforcement learning execution unit 130 records the result of each process of the steps S122 to S126 in the result log. In other words, the reinforcement learning execution unit 130 updates the result log (step S127).

Next, the reinforcement learning execution unit 130 checks whether the current state of the IT system confirmed in step S124 corresponds to the end state (step S128). The end state is defined for each reinforcement learning task. The end state is usually described in the reinforcement learning task definition.

If the current state of the IT system is the end state (Yes in step S128), the reinforcement learning execution unit 130 terminates the reinforcement learning process.

If the current state of the IT system is not the end state (No in step S128), the reinforcement learning execution unit 130 returns to step S122 and continues to execute the reinforcement learning process.

The reinforcement learning execution unit 130 usually performs the reinforcement learning process by repeating the entire process shown in FIG. 8 several more times. The learning log obtained by repeating the entire process multiple times is called an episode, which is combined log data of the learning logs of each time.

[Effect of the first example embodiment]

The dependence relationship detection device 100 of this example embodiment provides a function for verifying, without manual intervention, a dependence relationship between the system state and the operation that is difficult to verify sufficiently, which is defined in the template used in the deployment of IT systems by an automation tool.

Specifically, the dependence relationship detection device 100 of this example embodiment executes a reinforcement learning task that learns the change procedure of an IT system using a template provided by an automation tool that is the target of dependence relationship verification. The reinforcement learning execution unit 130 that executes the reinforcement learning task performs operations defined in the template under various conditions during the learning.

Next, the reinforcement learning execution unit 130 records a result of the operations performed in a result log. The result log shows the verification result for the operation in a practical situation, selected from among many possible operations to be verified with respect to the template provided by the automation tool to be verified.

When the reinforcement learning task is executed, not only the definition in the general reinforcement learning task but also the template correspondence that shows correspondence between the template, the state, and the action is specified in advance to the dependence relationship detection device 100 of this example embodiment. The definitions in a general reinforcement learning task are, for example, a state definition, an action definition, a learning algorithm definition, a search method definition, and a reward function definition.

The result log analysis unit 140 confirms whether there is excess or deficiency in the dependence relationship defined in the template by analyzing whether or not the intended operation transitions any state to the expected state based on the information indicating the template correspondence and the result log. Next, the analysis result output unit 150 presents the confirmed result to the user.

Therefore, the user of the dependence relationship detection device 100 of this example embodiment can detect the dependence relationship of the operation defined in the template without manually determining, executing, and evaluating the verification contents of the template provided by the automation tool.

### Second Example Embodiment

[Description of Configuration]

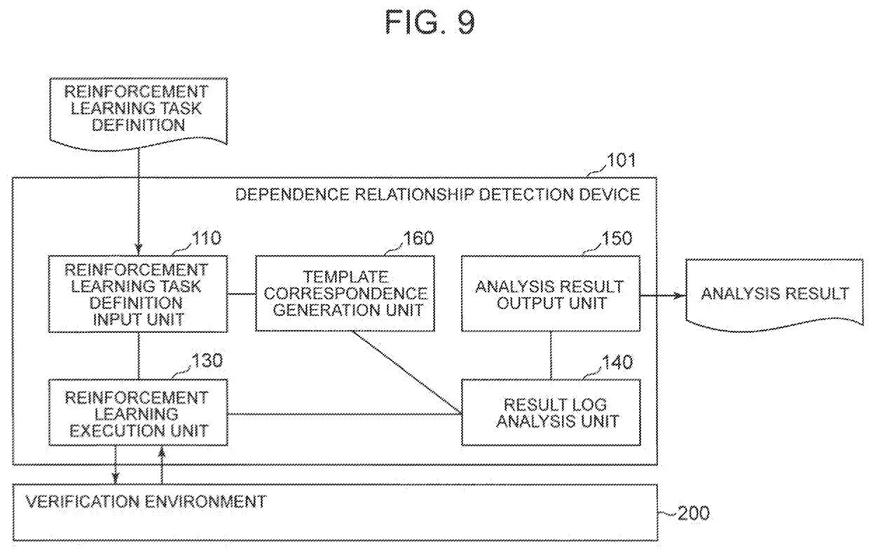

Next, the second example embodiment of the dependence relationship detection device according to the present invention will be described with reference to the drawings. FIG. 9 is a block diagram showing an example of the configuration of the second example embodiment of a dependence relationship detection device according to the present invention.

As shown in FIG. 9, the dependence relationship detection device 101 of this example embodiment includes a reinforcement learning task definition input unit 110, a reinforcement learning execution unit 130, a result log analysis unit 140, an analysis result output unit 150, and a template correspondence generation unit 160.

Unlike the dependence relationship detection device 100 of the first example embodiment, the dependence relationship detection device 101 of this example embodiment has a template correspondence generation unit 160 instead of a template correspondence input unit 120. Other than the template correspondence generation unit 160, the configuration of the dependence relationship detection device 101 of this example embodiment is the same as that of the dependence relationship detection device 100 of the first example embodiment.

As shown in FIG. 1, a template correspondence is input to the dependence relationship detection device 100 of the first example embodiment from the outside. In this example embodiment, the template correspondence generation unit 160 generates a template correspondence based on a reinforcement learning task definition input from the reinforcement learning task definition input unit 110.

The template correspondence generation unit 160 generates a template correspondence according to pre-defined rules based on an action, a state, and a template name. The contents of the reinforcement learning task definition in this example embodiment must be applicable to the rules used by the template correspondence generation unit 160.

[Description of Operation]

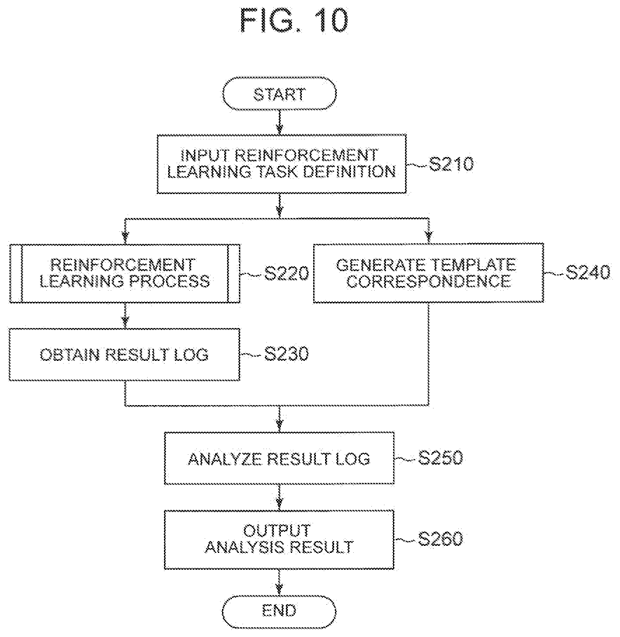

Hereinafter, the operation of outputting the analysis result of the dependence relationship detection device 101 of this example embodiment will be described with reference to FIG. 10. FIG. 10 is a flowchart showing an operation of an analysis result output process by the dependence relationship detection device 101 of a second example embodiment.

First, the user inputs a reinforcement learning task definition to the reinforcement learning task definition input unit 110 (step S210). Next, the reinforcement learning task definition input unit 110 inputs the input reinforcement learning task definition to the reinforcement learning execution unit 130 and the template correspondence generation unit 160.

Next, the template correspondence generation unit 160 generates a template correspondence based on the input reinforcement learning task definition (step S240). Next, the template correspondence generation unit 160 inputs the generated template correspondence to the result log analysis unit 140.

Each of the processes of step 5220 to step 5230 is the same as each of the processes of step 5120 to step 5130 shown in FIG. 7. Also, each of the processes of step 5250 to step 5260 is the same as each of the processes of step S150 to step S160 shown in FIG. 7.

[Effect of the second example embodiment]

Users who understand the rules for generating the template correspondence can obtain an analysis result of the dependence relationship by simply inputting simpler contents than in the first example embodiment to the dependence relationship detection device 101 of this example embodiment.

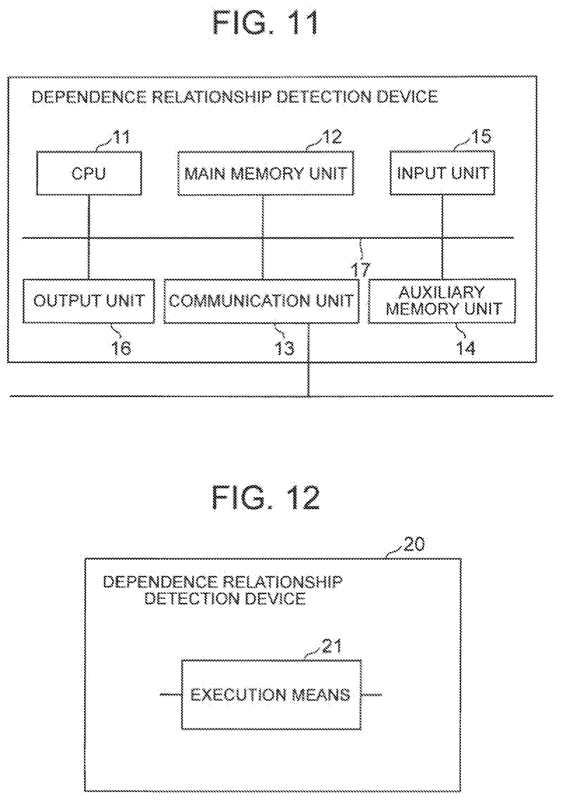

A specific example of a hardware configuration of a dependence relationship detection device according to each of the example embodiments will be described below. FIG. 11 is an explanatory diagram showing an example of a hardware configuration of a dependence relationship detection device according to the present invention.

The dependence relationship detection device shown in FIG. 11 includes a CPU (Central Processing Unit) 11, a main memory unit 12, a communication unit 13, and an auxiliary memory unit 14. The dependence relationship detection device also includes an input unit 15 for the user to operate and an output unit 16 for presenting a processing result or a progress of the processing contents to the user.

The dependence relationship detection device is realized by software, with the CPU 11 shown in FIG. 11 executing a program that provides a function that each component has.

Specifically, each function is realized by software as the CPU 11 loads the program stored in the auxiliary memory unit 14 into the main memory unit 12 and executes it to control the operation of the dependence relationship detection device.

The dependence relationship detection device shown in FIG. 11 may include a DSP (Digital Signal Processor) instead of the CPU 11. Alternatively, the dependence relationship detection device shown in FIG. 11 may include both the CPU 11 and the DSP.

The main memory unit 12 is used as a work area for data and a temporary save area for data. The main memory unit 12 is, for example, RAM (Random Access Memory).

The communication unit 13 has a function of inputting and outputting data to and from peripheral devices through a wired network or a wireless network (information communication network).

The auxiliary memory unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse. The reinforcement learning task definition input unit 110 and the template correspondence input unit 120 are realized by the input unit 15.

The output unit 16 has a function to output data. The output unit 16 is, for example, a display device such as a liquid crystal display device, or a printing device such as a printer. The analysis result output unit 150 is realized by the output unit 16.

As shown in FIG. 11, in the dependence relationship detection device, each component is connected to the system bus 17.

The auxiliary memory unit 14 stores programs for realizing, for example, the reinforcement learning task definition input unit 110, the template correspondence input unit 120, the reinforcement learning execution unit 130, the result log analysis unit 140, and the analysis result output unit 150 in the first example embodiment.

The auxiliary memory unit 14 also stores programs for realizing, for example, the reinforcement learning task definition input unit 110, the reinforcement learning execution unit 130, the result log analysis unit 140, and the template correspondence generation unit 160 in the second example embodiment.

The dependence relationship detection device may be realized by hardware. For example, the dependence relationship detection device 100 may be implemented with a circuit that contains hardware components inside such as an LSI (Large Scale Integration) that realize the functions shown in FIG. 1.

Some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Next, an overview of the present invention will be explained. FIG. 12 is a block diagram showing an overview of a dependence relationship detection device according to the present invention. The dependence relationship detection device 20 according to the present invention includes an execution means 21 (for example, the reinforcement learning execution unit 130) which executes a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

With such a configuration, the dependence relationship detection device can easily detect a dependence relationship in a relatively large template.

The dependence relationship detection device 20 may include an analysis means (for example, the result log analysis unit 140) which analyzes whether or not a condition exists for success of the operation to be executed by the automation tool using the template, based on correspondence information indicating a correspondence between the template, the operation defined in the template and the states to which the components are expected to transition due to the operation, and an execution result of the reinforcement learning task that indicates the states of the components before the operation is executed and the states of the components after the operation is executed.

The correspondence information is information that associates an action (operation) in the reinforcement learning task definition with a changed state after the action is executed. The correspondence information also includes information that specifies a template used in an automation tool which is the means required to execute the action.

With such a configuration, the dependence relationship detection device can easily detect a dependence relationship using the template correspondence.

The analysis means may present the condition for success of the operation obtained by statistically analyzing the multiple execution results of the reinforcement learning task as a dependence relationship of the operation.

With such a configuration, the dependence relationship detection device can present the specific contents of the dependence relationship.

The dependence relationship of the operation may be a relationship between the operation and the state of the component.

With such a configuration, the dependence relationship detection device can present the state of the components for success of the operation.

The dependence relationship detection device 20 may include a generation means (for example, the template correspondence generation unit 160) which generates the correspondence information based on the reinforcement learning task definition. The generation means may generate the correspondence information by interpreting the reinforcement learning task definition with a predetermined rule regarding a feature such as a name of a state definition or a name of an action definition.

With such a configuration, the dependence relationship detection device can save effort of the user.

The execution means 21 may search for the operation to be executed before learning the deployment procedure according to a search algorithm.

With such a configuration, the dependence relationship detection device can cover the operations defined in the template.

While the present invention has been described with reference to the example embodiments and examples, the present invention is not limited to the aforementioned example embodiments and examples. Various changes understandable to those skilled in the art within the scope of the present invention can be made to the structures and details of the present invention.

This application claims priority based on Japanese Patent Application No. 2019-019377 filed on Feb. 6, 2019, the disclosure of which is incorporated herein in its entirety.

The whole or part of the example embodiments disclosed above can be described as, but not limited to, the following supplementary notes.

(Supplementary note 1) A dependence relationship detection device comprising: an execution means which executes a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

(Supplementary note 2) The dependence relationship detection device according to Supplementary note 1, further comprising: an analysis means which analyzes whether or not a condition exists for success of the operation to be executed by the automation tool using the template, based on correspondence information indicating a correspondence between the template, the operation defined in the template and the states to which the components are expected to transition due to the operation, and an execution result of the reinforcement learning task that indicates the states of the components before the operation is executed and the states of the components after the operation is executed.

(Supplementary note 3) The dependence relationship detection device according to Supplementary note 2, wherein the analysis means presents the condition for success of the operation obtained by statistically analyzing the multiple execution results of the reinforcement learning task as a dependence relationship of the operation.

(Supplementary note 4) The dependence relationship detection device according to Supplementary note 3, wherein the dependence relationship of the operation is a relationship between the operation and the state of the component.

(Supplementary note 5) The dependence relationship detection device according to any one of Supplementary notes 2 to 4, further comprising: a generation means which generates the correspondence information based on the reinforcement learning task definition.

(Supplementary note 6) The dependence relationship detection device according to Supplementary note 5, wherein the generation means generates the correspondence information by interpreting the reinforcement learning task definition with a predetermined rule regarding either a feature of a name of a state definition or a feature of a name of an action definition.

(Supplementary note 7) The dependence relationship detection device according to any one of Supplementary notes 1 to 6, wherein the execution means searches for the operation to be executed before learning the deployment procedure according to a search algorithm.

(Supplementary note 8) A dependence relationship detection method comprising: executing a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

(Supplementary note 9) The dependence relationship detection method according to Supplementary note 8, further comprising: analyzing whether or not a condition exists for success of the operation to be executed by the automation tool using the template, based on correspondence information indicating a correspondence between the template, the operation defined in the template and the states to which the components are expected to transition due to the operation, and an execution result of the reinforcement learning task that indicates the states of the components before the operation is executed and the states of the components after the operation is executed.

(Supplementary note 10) A computer readable recording medium storing a dependence relationship detection program that, when executed by a computer, performs:

executing a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

(Supplementary note 11) The dependence relationship detection program according to Supplementary note 10, when executed by the computer, performs: executing an analysis process of analyzing whether or not a condition exists for success of the operation to be executed by the automation tool using the template, based on correspondence information indicating a correspondence between the template, the operation defined in the template and the states to which the components are expected to transition due to the operation, and an execution result of the reinforcement learning task that indicates the states of the components before the operation is executed and the states of the components after the operation is executed.

### INDUSTRIAL APPLICABILITY

This invention is suitably applied to a system automatic change tool that automatically change an IT system.

### REFERENCE SIGNS LIST

11 CPU

12 Main memory unit

13 Communication unit

14 Auxiliary memory unit

15 Input unit

16 Output unit

17 System bus

20, 100, 101 Dependence relationship detection device

21 Execution means

110 Reinforcement learning task definition input unit

120 Template correspondence input unit

130 Reinforcement learning execution unit

140 Result log analysis unit

150 Analysis result output unit

160 Template correspondence generation unit

200 Verification environment

What is claimed is:

1. A dependence relationship detection device comprising:
a memory that stores a set of instructions; and
at least one processor configured to execute the set of instructions to execute a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

2. The dependence relationship detection device according to claim 1, wherein the at least one processor configured to execute the set of instructions to analyze whether or not a condition exists for success of the operation to be executed by the automation tool using the template, based on correspondence information indicating a correspondence between the template, the operation defined in the template and the states to which the components are expected to transition due to the operation, and an execution result of the reinforcement learning task that indicates the states of the components before the operation is executed and the states of the components after the operation is executed.

3. The dependence relationship detection device according to claim 2, wherein the at least one processor configured to execute the set of instructions to present the condition for success of the operation obtained by statistically analyzing the multiple execution results of the reinforcement learning task as a dependence relationship of the operation.

4. The dependence relationship detection device according to claim 3, wherein the dependence relationship of the operation is a relationship between the operation and the state of the component.

5. The dependence relationship detection device according to claim 2, wherein the at least one processor configured to execute the set of instructions to generate the correspondence information based on the reinforcement learning task definition.

6. The dependence relationship detection device according to claim 5, wherein at least one processor configured to execute the set of instructions to generate the correspondence information by interpreting the reinforcement learning task definition with a predetermined rule regarding either a feature of a name of a state definition or a feature of a name of an action definition.

7. The dependence relationship detection device according to claim 1, wherein the at least one processor configured to execute the set of instructions to search for the operation to be executed before learning the deployment procedure according to a search algorithm.

8. A dependence relationship detection method comprising:
executing a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

9. The dependence relationship detection method according to claim 8, further comprising:
analyzing whether or not a condition exists for success of the operation to be executed by the automation tool using the template, based on correspondence information indicating a correspondence between the template, the operation defined in the template and the states to which the components are expected to transition due to the operation, and an execution result of the reinforcement learning task that indicates the states of the components before the operation is executed and the states of the components after the operation is executed.

10. A non-transitory computer readable recording medium storing a dependence relationship detection program that, when executed by a computer, performs:
executing a reinforcement learning task of learning a deployment procedure, by using a reinforcement learning task definition in which an operation to a system to be constructed, the operation being defined for a template for use, in deployment, by an automation tool for automatically deploying the system to be constructed, and states of components of the system to be constructed are defined, the deployment procedure being premised on the states of the components after execution of the operation.

11. The non-transitory computer readable recording medium storing the dependence relationship detection program according to claim 10, when executed by the computer, performs:
executing an analysis process of analyzing whether or not a condition exists for success of the operation to be executed by the automation tool using the template, based on correspondence information indicating a correspondence between the template, the operation defined in the template and the states to which the components are expected to transition due to the operation, and an execution result of the reinforcement learning task that indicates the states of the components before the operation is executed and the states of the components after the operation is executed.

12. The dependence relationship detection device according to claim 3, wherein the at least one processor configured to execute the set of instructions to generate the correspondence information based on the reinforcement learning task definition.

13. The dependence relationship detection device according to claim 4, wherein the at least one processor configured to execute the set of instructions to generate the correspondence information based on the reinforcement learning task definition.

14. The dependence relationship detection device according to claim 12, wherein the at least one processor configured to execute the set of instructions to generate the correspondence information by interpreting the reinforcement learning task definition with a predetermined rule regarding either a feature of a name of a state definition or a feature of a name of an action definition.

15. The dependence relationship detection device according to claim 13, wherein the at least one processor configured to execute the set of instructions to generate the correspondence information by interpreting the reinforcement learning task definition with a predetermined rule regarding either a feature of a name of a state definition or a feature of a name of an action definition.

16. The dependence relationship detection device according to claim 2, wherein the at least one processor configured to execute the set of instructions to search for the operation to be executed before learning the deployment procedure according to a search algorithm.

17. The dependence relationship detection device according to claim 3, wherein the at least one processor configured to execute the set of instructions to search for the operation to be executed before learning the deployment procedure according to a search algorithm.

18. The dependence relationship detection device according to claim 4, wherein the at least one processor configured to execute the set of instructions to search for the operation to be executed before learning the deployment procedure according to a search algorithm.

19. The dependence relationship detection device according to claim 5, wherein the at least one processor configured to execute the set of instructions to search for the operation to be executed before learning the deployment procedure according to a search algorithm.

20. The dependence relationship detection device according to claim 6, wherein the at least one processor configured to execute the set of instructions to search for the operation to be executed before learning the deployment procedure according to a search algorithm.
